(19) United States
(12) Patent Application Publication
(10) Pub. No.: US 2023/0202922 A1
(43) Pub. Date: Jun. 29, 2023

(54) FENG 200 YEAR CONCRETE

(71) Applicant: HC Properties Inc, Clinton (CA)

(72) Inventor: John Martin Halliwell, Clinton (CA)

(21) Appl. No.: 17/561,785

(22) Filed: Dec. 24, 2021

(51) Int. Cl. C04B 7/42; C04B 22/06; C04B 24/00; C04B 20/00

(52) U.S. Cl. CPC C04B 7/424; C04B 20/006; C04B 22/06; C04B 24/00; B82Y 40/00

(57) ABSTRACT

A concrete composition includes a cement, a fine aggregate, a coarse aggregate and water. The concrete composition also includes a magnesium aluminosilicate material, a colloidal silica material, a MgO material, a colloidal titanium dioxide material and a colloidal graphene oxide material.

### FIELD

This disclosure relates generally to concrete mixtures for forming slabs, walls and for other structural applications, and more particularly to concrete mixtures that form substantially waterproof structures after hardening.

### BACKGROUND

Buildings and construction together account for more than 30% of global final energy use and almost 40% of energy-related carbon dioxide (CO₂) emissions when upstream power generation is included. Concrete is one of the biggest contributors to the carbon footprint of buildings and infrastructure. Every year, more than 10 billion tons of concrete are used, which requires more than 4 billion tons of cement, accounting for around 8% of all CO₂ emissions worldwide. Despite improvements in processes and control measures, the manufacture of concrete still emits between 70 and 90 kg of CO₂ per ton.

The main environmental impact of concrete occurs during manufacture, especially the production of cementitious binder, reinforcing steel, mining, and transport of aggregates, and the energy used to transport the concrete to the job site.

Reducing the impact of concrete and the construction industry will become even more important in coming years as rapid urbanization and economic development increases demand for new buildings and, thus, for concrete and cement. One of the most important and attainable ways of reducing the carbon footprint and other environmental impacts of concrete construction is to extend the life of the buildings, roads and other structures that are built using concrete. Since water permeation leads to corrosion and frost-thaw damage, etc., providing waterproof concrete structures that are resistant to water permeation is an area of intense interest due to the potential to significantly extend the time before it becomes necessary to demolish existing structures and build new ones.

As is well known, concrete is a composite construction material composed primarily of the reaction products of hydraulic cement, aggregates, and water. Water is both a reactant for the cement component and is necessary to provide desired flow characteristics (e.g., spread and/or slump) and ensure consolidation of freshly mixed concrete to prevent formation of strength-reducing voids and other defects. Chemical admixtures may be added to freshly mixed concrete to modify characteristics such as rheology (i.e., plastic viscosity and yield stress), water retention, and set time. Although some of the water reacts with the cement component to form crystalline hydration products, a substantial portion remains unreacted and is typically gradually removed from the concrete by evaporation.

Crack formation at or near the surface of the concrete, due to shrinkage of concrete during hydration and hardening, are a common occurrence and may result in weaker structure and poor aesthetics. Unfortunately, these cracks provide a pathway that allows water to permeate into the concrete, which may lead to corrosion of internal reinforcements, leaching of the aggregates and binders, and ultimately result in premature failure of the concrete structure and the need to build a replacement. Different mechanisms are known to result in crack formation. For instance, plastic shrinkage occurs in a freshly mixed concrete, with loss of water by evaporation from its surface, after placing and before hardening of the concrete. This can lead to plastic shrinkage cracking if the rate of evaporation is higher than that of the bleeding water rising to the surface of the concrete. Drying shrinkage occurs due to the loss of moisture from concrete after it hardens. Several factors impact shrinkage, for example: the cement and water content, size of the aggregates, aggregate to cement ratio, excessive fines, admixtures, cement composition, temperature, humidity, curing process, etc. In general, it is not uncommon for these effects to produce cracks up to 1 mm or more in width in the hardened concrete structure, which is unacceptable for applications in which the concrete structure may be exposed to water.

Various technologies have been used to reduce shrinkage, using chemicals or fibers or mixes thereof. For instance, the use of cellulose fibers, polyethylene fibers, polypropylene fibers etc., has been widely practiced in the concrete industry for many years. However, current technologies have thus far failed to achieve a reduction in crack size that is necessary to prevent water permeation and avoid premature failure of the concrete structure.

It would therefore be beneficial to provide a solution that overcomes at least some of the above-mentioned drawbacks.

### SUMMARY OF EMBODIMENTS

In accordance with an aspect of at least one embodiment, there is provided a concrete composition, comprising: a cement, a fine aggregate, a coarse aggregate and water, wherein a weight ratio of water to cement is between 0.33 and 0.36 and is sufficient for hydraulic setting of the cement; a magnesium oxide material; a magnesium aluminosilicate material; a colloidal silica material; a colloidal graphene oxide material; a colloidal titanium dioxide material, wherein a total amount of water is added to the cement, fine aggregate, coarse aggregate and magnesium oxide material, and wherein 20% of the total water is added in the form of slurries, in which a first slurry containing the magnesium aluminosilicate material comprises 10% of the total water, a second slurry containing the colloidal silica material comprises 5% of the total water, a third slurry containing the graphene oxide material comprises 2.5% of the total water and a fourth slurry containing the colloidal titanium dioxide material comprises 2.5% of the total water.

In accordance with an aspect of at least one embodiment, there is provided a hardened concrete structure fabricated from a concrete composition, wherein prior to hardening the concrete composition comprises: a cement, a fine aggregate, a coarse aggregate and water, wherein a weight ratio of water to cement is between 0.33 and 0.36 and is sufficient for hydraulic setting of the cement; a magnesium oxide material; a magnesium aluminosilicate material; a colloidal silica material; a colloidal graphene oxide material; a colloidal titanium dioxide material, wherein a total amount of water is added to the cement, fine aggregate, coarse aggregate and magnesium oxide material, and wherein 20% of the total water is added in the form of slurries, in which a first slurry containing the magnesium aluminosilicate material comprises 10% of the total water, a second slurry containing the colloidal silica material comprises 5% of the total water, a third slurry containing the graphene oxide material comprises 2.5% of the total water and a fourth slurry containing the colloidal titanium dioxide material comprises 2.5% of the total water.

### DETAILED DESCRIPTION

While the present teachings are described in conjunction with various embodiments and examples, it is not intended that the present teachings be limited to such embodiments. On the contrary, the present teachings encompass various alternatives and equivalents, as will be appreciated by those of skill in the art. All statements herein reciting principles, aspects, and embodiments of this disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

As used herein, the terms “first,” “second,” and so forth are not intended to imply sequential ordering, but rather are intended to distinguish one element from another, unless explicitly stated to the contrary. Similarly, sequential ordering of method steps does not imply a sequential order of their execution, unless explicitly stated.

As used herein, “Cement” refers to a binder that sets and hardens and brings materials together. The most common cement is Ordinary Portland Cement (OPC) and a series of Portland cements blended with other cementitious materials, such as Portland Pozzolana Cement (PPC) and their typical blends available in the market.

As used herein, “Ordinary Portland cement” refers to a hydraulic cement made from grinding clinker with gypsum. Portland cement contains calcium silicate, calcium aluminate and calcium ferroaluminate phases. These mineral phases react with water to produce strength.

As used herein, “Fibers” refers to a material used to increase concrete’s structural performance. Fibers are also responsible for reducing cracking, abrasion resistance, surface finishes etc. For example, fibers include steel fibers, glass fibers, synthetic fibers, and natural fibers.

As used herein, “Admixture” refers to a chemical substance used to modify or improve concrete’s properties in fresh and hardened state. These could be air entrainers, water reducers, set retarders, accelerators, stabilizers, superplasticizers, and others.

As used herein, “Concrete” refers to a combination of cement, fine aggregates, coarse aggregates, and water. Admixture can also be added to provide specific properties such as flow, lower water content, acceleration.

As used herein, “Structural applications” refers to a construction material having a compressive strength greater than 25 MPa.

As used herein, “Coarse aggregates” refers to a manufactured, natural or recycled mineral with a particle size typically of about 20 mm. Coarse aggregates may also include mineral with a particle size outside this range, such as for instance ±5-10%.

As used herein, “Fine aggregates” refers to a manufactured, natural or recycled minerals with a particle size between 0.1 mm and 1 mm. Fine aggregates may also include mineral with a particle size outside this range.

As used herein, “Shrinkage” refers to the reduction in the volume of concrete caused by the loss of moisture as concrete hardens or dries. Because of the volume loss, concrete shrinkage can lead, for example, to cracking when base friction or other restraint occurs.

As used herein, the water to cement ratio “w/c” refers to the total free water (w) mass in kg divided by the total cement mass in kg.

As used herein “Batch total weight” refers to the combined weight of cement, fine aggregate, coarse aggregate, and water added to form the concrete composition but excludes the weight of all admixture components.

As used herein “Batch total dry weight” refers to the combined weight of cement, fine aggregate, and coarse aggregate added to form the concrete composition but excludes the weight of all admixture components and added water.

According to a first aspect, the present disclosure relates to a concrete composition including i) cement, ii) a fine aggregate, iii) a coarse aggregate, iv) a magnesium aluminosilicate, v) colloidal silica vi) colloidal titanium dioxide vii) colloidal graphene oxide viii) magnesium oxide (MgO) or a blend of MgO and calcium oxide (CaO), and ix) water. After curing, a compressive strength in the range between about 25 MPa and 35 MPa, determined using the standard 28-day lab test for compressive strength of a concrete cylinder, is observed, which makes the disclosed concrete composition suitable for structural applications. The specific compressive strength may be tailored to suit the requirements of a particular project in which the concrete composition is to be used. Advantageously, the disclosed concrete composition, after curing, exhibits reduced cracking and improved waterproof properties relative to known compositions.

The concrete composition of this disclosure provides improved performance, primarily against plastic shrinkage cracking, thermal cracking, and drying shrinkage cracking. The performance of the disclosed concrete composition is improved relative to prior art compositions by the inclusion of specific admixture components which exhibits a useful and unexpected synergy. The inclusion of an expansion agent (i.e., the MgO/CaO blend) acts against the tensile forces that develop in the early setting stage of concrete hardening and that are responsible for plastic shrinkage cracking. The inclusion of colloidal silica reduces curing requirements and eliminates wet curing, and develops concrete strength earlier compared to typical mixes, thus reducing schedule times. The inclusion of colloidal silica furthermore minimizes capillary formation, bleeding of water and hence, drying shrinkage cracking compared to typical mixes. The inclusion of magnesium aluminosilicate provides improved workability and enables reduced water content (w/c ratio). The inclusion of colloidal titanium (titanium dioxide particles) increases the flexural and compressive strength of the concrete. The inclusion of colloidal graphene reinforces the concrete, making it stronger.

A currently preferred composition will now be described as a specific and non-limiting embodiment. However, as discussed in more detail below, the relative amount of the various components may be varied depending on the requirements of a specific application. The currently preferred composition includes a cement, a fine aggregate, a coarse aggregate, and water. The cement is preferably a hydraulic cement, preferably a sulfoaluminous clinker, preferably Portland cement. Portland cement refers to the most common type of cement in general use around the world, developed from types of hydraulic lime and usually originating from limestone. It is a fine powder produced by heating materials in a kiln to form what is called clinker, grinding the clinker, and adding small amounts of other materials. The Portland cement is made by heating limestone (calcium carbonate) with other materials (such as clay) to >1400° C. in a kiln, in a process known as calcination, whereby a molecule of carbon dioxide is liberated from the calcium carbonate to form calcium oxide, or quicklime, which is then blended with the other materials that have been included in the mix to from calcium silicates and other cementitious compounds. The resulting hard substance, called “clinker” is then ground with a small amount of gypsum into a powder to make ordinary Portland cement (OPC). Several types of Portland cement are available with the most common being called ordinary Portland cement (OPC) which is grey in color. The low cost and widespread availability of the limestone, shales, and other naturally occurring materials used in Portland cement make it one of the low-cost materials widely used throughout the world. Of course, as will be apparent to a person having ordinary skill in the art, other types of cement, such as for instance Portland Pozzolana Cements (PPC) and their typical blends available in the market, may be used as the cement in the currently preferred composition. Portland Pozzolana Cements are produced by either inter-grinding of OPC clinker along with gypsum and pozzolanic materials in certain proportions or grinding the OPC clinker, gypsum and Pozzolanic materials separately and thoroughly blending them in certain proportions.

The fine aggregate may be of natural or synthetic origin and may have a particle size in the range of 0.1 mm to 1.0 mm. The fine aggregate may be sand or another suitable material having a similar particle size. The coarse aggregate also may be of natural or synthetic origin and may have a particle size typically of about 20 mm, although the particle size may be either smaller or larger than 20 mm as will be understood by a person having ordinary skill in the art (i.e., ±5-10%). The coarse aggregate may be limestone, pea stone, standard crushed stone, or another suitable material. Aggregates, from different sources, or produced by different methods, may differ considerably in particle shape, size, and texture. Shape of the aggregates of the present disclosure may be cubical and reasonably regular, essentially rounded, or angular and irregular. Surface texture may range from relatively smooth with small, exposed pores to irregular with small to large, exposed pores. Particle shape and surface texture of both the fine aggregate and the coarse aggregate influence proportioning of mixtures in such factors as workability, pumpability, fine-to-coarse aggregate ratio, cement binder content, and water requirement.

A typical batch weight is 2400 kg producing 1 m³ of concrete, although the total batch size may be greater or less than this value to suit a particular requirement. In the currently preferred composition, a weight ratio of the cement to the fine aggregate is between about 1:1.5 and about 1:2. A weight ratio of the cement to the coarse aggregate is between about 1:2.5 and about 1:3. A weight ratio of the fine aggregate to the coarse aggregate is between about 1:1.25 and about 1: 1.66. Specific and non-limiting examples of suitable ratios of cement to fine aggregate to coarse aggregate include 1:1.5:2.5, 1:2:2.5, and 1:2:3. Of course, other ratios within the above-mentioned ranges are also possible.

The amount of water added to the dry mixture of cement, fine aggregate and coarse aggregate is sufficient for hydraulic setting of the cement. More specifically, the water to cement content (kg/kg) is between about 0.33 and about 0.36 in the currently preferred composition. The relative amounts of cement, fine aggregate, and coarse aggregate, with a water content between 0.33 and 0.36, yields a concrete mixture that is suitable for fully filling forms, either with or without vibration and/or packing. The currently preferred concrete composition may be prepared e.g., in a ready-mix truck at an appropriate time prior to a scheduled delivery at a work site, and then dispensed from the ready-mix truck into wheelbarrows or directly into pre-constructed forms, etc. Vibration and/or packing may be used to ensure that all void spaces are filled, if desired. Suitable amounts of each of the above-mentioned components may be within the following ranges: 360-470 kg of cement; 650-850 kg of fine aggregates; 910-1150 kg of coarse aggregates; and 120-170 L of water. The amount of each component is adjustable within the above-mentioned ranges to produce a batch total weight of concrete of 2400 kg and yielding 1 m³ of concrete.

The currently preferred composition includes chemical admixtures and mineral admixtures to improve the physical properties of the wet mix or the finished concrete material. In particular, the currently preferred composition includes i) magnesium oxide (MgO) or a blend of magnesium oxide (MgO) and calcium oxide (CaO) (MgO/CaO blend), ii) a magnesium aluminosilicate such as for instance palygorskite and/or attapulgite, iii) colloidal silica iv) colloidal titanium (TiO particles) and v) colloidal graphene oxide. The currently preferred composition optionally includes additional admixtures, such as for instance iv) plasticizers/water reducers, e.g., lignosulfonate-based additives, and/or v) micro/macro fibers, e.g., steel fibers or synthetic fibers (e.g., polypropylene, polyvinyl alcohol, etc.). Each of the above-mentioned admixtures is discussed in greater detail in the following paragraphs.

The MgO (or MgO/CaO blend) is added, in the dry state, to the mixture of cement, fine aggregate and coarse aggregate described above, in an amount of 3% of the cement dry weight. More particularly, the MgO or MgO/CaO blend is an expansion agent that counteracts the tensile forces across the concrete body during the initial setting state, which leads to a significant reduction in plastic shrinkage cracking after the concrete composition hardens. It has been found that a blend, containing the relative amounts of MgO, CaO and silica fume that are disclosed in the following paragraph, has a synergistic effect with the other admixtures resulting in the formation of cracks that are orders of magnitude smaller than the cracks that are formed using prior art concrete compositions. For instance, after hardening, the disclosed concrete composition may have cracks that are no larger than about 0.01 mm in width, preferably no larger than about 0.001 mm in width.

Water is added to the dry mix components described above. The total amount of water is derived as approximately 80% standard water (no admixtures present) and 20% non-standard water (slurry containing the admixture components). For example, the 20% non-standard water is composed of: i) 10% magnesium aluminosilicate slurry, ii) 5% colloidal silica slurry, iii) 2.5% colloidal graphene slurry and iv) 2.5% colloidal titanium slurry. None of the above-mentioned components of the non-standard water are 0%, however the actual amounts used may vary depending on the particular application.

The magnesium aluminosilicate, such as for instance palygorskite and/or attapulgite, is added as a slurry to the dry components of currently preferred concrete composition as described above. The magnesium aluminosilicate admixture acts as a binder, thixotrope, reinforcement additive, anti-settling agent and rheology modifier. The magnesium aluminosilicate can be introduced at any point in the process with similar performance. In the currently preferred composition, the magnesium aluminosilicate slurry is about 10% of the batch total weight of water.

The colloidal silica is also provided in slurry form and the silica particles in the slurry may have a size between about 1 nm and about 100 nm and a surface area of between about 300 m²/g and about 900 m²/g. A currently preferred colloidal silica slurry has silica particle between about 1 nm and about 50 nm in size and a surface area between about 500 m²/g and about 600 m²/g. As noted above, the colloidal silica enables internal hydration and curing, promotes early strength acceleration, and increases workability by binding to the cement particles. The colloidal silica may be the last admixture component added. For instance, when the preferred concrete mixture is being prepared in a ready-mix truck, prior to adding the colloidal silica slurry the mixer is switched to discharge mode, and the mixer is turned to the point where the concrete mixture is on the final spiral of the mixer and about to fall off the chute. The mixer is then switched to mixing mode. The colloidal silica slurry is added, in a controlled manner, avoiding spillage onto the chute and avoiding contact with the internal surface of the mixer. Finally, the mixer spins at minimum speed of 70 rpm for at least 4 minutes to ensure proper dispersion across the volume of the concrete mixture.

Colloidal titanium (TiO₂ particles) and colloidal graphene oxide are also be added to the cement batch in slurry form. All three admixtures (colloidal silica, colloidal titanium dioxide, and colloidal graphene oxide) may be added as a blend (e.g., blended slurry), or separately (e.g., as separate slurries that are co-added to the batch at about the same time or at different times). In the currently preferred concrete composition, the amount of each one of the colloidal silica, the colloidal titanium dioxide, and the colloidal graphene oxide admixtures varies between greater than 0% and about 10% by weight of the water added to the batch, with the total combined weight of colloidal silica, colloidal titanium dioxide, and colloidal graphene oxide being equal to about 10% by weight of water added to the batch.

The currently preferred concrete composition may include additional but optional admixtures, which are in any case added prior to adding the colloidal silica slurry. Optional admixtures include at least plasticizers/water reducers (e.g., lignosulfonate-based additives). These additives are typically used to reduce water/cement ratio, provide additional fluidity/workability, strength and slow down the settling rates of concrete. The presently preferred concrete composition is compatible and consistent with the use of plasticizers falling in the low to mid-range capabilities. A plasticizer admixture component may be added in an amount of about 160 ml to about 1000 ml per 100 kg of dry cement, or about 570 ml to about 4600 ml in a typical 2400 kg batch total weight including water.

Another optional admixture includes at least micro/macro fibers, such as for instance glass, steel, nylon or other synthetic fibers (e.g., polypropylene fibers). The inclusion of steel and/or synthetic macro/micro fibers is to avoid all forms of internal cracking and limit the width of cracks when the presently preferred concrete composition is to be used in extreme weather conditions. Some specific and non-limiting examples of suitable synthetic fibers include polyvinyl alcohol (PVA) micro filament fibers with a fiber diameter in the range between about 24 microns to about 100 micron and a fiber length in the range between about 6 mm to about 50 mm. PVA fibers can be suggested as the most preferred option. Alternatively, polypropylene fibers (PPF) with a fiber diameter in the range between about 50 microns to about 200 microns and a fiber length in the range between about 12 mm to about 65 mm may be used. The type of fiber selected will depend at least partially upon the specific application for the concrete batch. A micro/macro fiber admixture component may be added in an amount of about 0.45 kg to about 2.5 kg in a typical 2400 kg batch total weight including water.

In terms of the present disclosure, the term “composition” may refer to the fresh state solid cement or concrete mixture comprising the cement, the fine aggregate, the coarse aggregate, the magnesium aluminosilicate, the colloidal silica and/or colloidal titanium dioxide and/or colloidal graphene oxide, the MgO/CaO blend before the addition of the water and/or additional chemical and/or mineral admixtures. The “composition” may refer to a formable or self-placing fluid concrete mixture after the addition of all or a portion of the water and/or additional chemical and/or mineral admixtures. The “composition” may refer to the hardened matrix concrete after any period of setting once the hydration process has started. In a preferred embodiment, all components of the concrete composition of the present disclosure are homogeneously dispersed in the composition.

Throughout the description and claims of this specification, the words “comprise”, “including”, “having” and “contain” and variations of the words, for example “comprising” and “comprises” etc., mean “including but not limited to”, and are not intended to, and do not exclude other components.

When a range is given between “x” and “y” the range is intended to include both “x” and “y.” The term “about” means ±10% and preferably ±5% when applied to values in a range or to single values.

It will be appreciated that variations to the foregoing embodiments of the disclosure can be made while still falling within the scope of the disclosure. Each feature disclosed in this specification, unless stated otherwise, may be replaced by alternative features serving the same, equivalent or similar purpose. Thus, unless stated otherwise, each feature disclosed is one example only of a generic series of equivalent or similar features.

All of the features disclosed in this specification may be combined in any combination, except combinations where at least some of such features and/or steps are mutually exclusive. In particular, the preferred features of the disclosure are applicable to all aspects of the disclosure and may be used in any combination. Likewise, features described in non-essential combinations may be used separately (not in combination).

What is claimed is:

1. A concrete composition, comprising:
a cement, a fine aggregate, a coarse aggregate and water, wherein a weight ratio of water to cement is between 0.33 and 0.36 and is sufficient for hydraulic setting of the cement;
a magnesium oxide material;
a magnesium aluminosilicate material;
a colloidal silica material;
a colloidal graphene oxide material;
a colloidal titanium dioxide material,
wherein a total amount of water is added to the cement, fine aggregate, coarse aggregate and magnesium oxide material, and wherein 20% of the total water is added in the form of slurries, in which a first slurry containing the magnesium aluminosilicate material comprises 10% of the total water, a second slurry containing the colloidal silica material comprises 5% of the total water, a third slurry containing the graphene oxide material comprises 2.5% of the total water and a fourth slurry containing the colloidal titanium dioxide material comprises 2.5% of the total water.

2. The concrete composition of claim 1, wherein cracks formed during hardening of the concrete composition are less than 0.01 mm in width.

3. The concrete composition of claim 1, wherein cracks formed during hardening of the concrete composition are less than 0.001 mm in width.

4. The concrete composition of claim 1, wherein a weight ratio of the cement to the fine aggregate is between 1:1.5 and 1:2, a weight ratio of the cement to the coarse aggregate is between 1:2.5 and 1:3, and a weight ratio of the fine aggregate to the coarse aggregate is between 1:1.25 and 1:1.66.

5. The concrete composition of claim 1, wherein the magnesium aluminosilicate material is at least one of palygorskite or attapulgite.

6. The concrete composition of claim 1, further comprising natural or synthetic fibers homogeneously distributed throughout the concrete composition.

7. The concrete composition of claim 6, wherein the natural or synthetic fibers are selected from the following: glass fibers, steel fibers, nylon fibers, polyvinyl alcohol fibers and polypropylene fibers.

8. The concrete composition of claim 1, further comprising a plasticizer admixture component.

9. The concrete composition of claim 1, further comprising a water reducer admixture component.

10. The concrete composition of claim 1, wherein the fine aggregate has a particle size in the range of 0.1 mm to 1.0 mm.

11. The concrete composition of claim 1, wherein the coarse aggregate has a particle size of about 20 mm.

12. The concrete composition of claim 1, wherein the colloidal silica is amorphous silica having a particle size between 1 nm and 100 nm and a surface area of between 300 m²/g and 900 m²/g.

13. The concrete composition of claim 1, wherein the colloidal silica is amorphous silica having a particle size between 1 nm and 50 nm and a surface area of between 500 m²/g and 600 m²/g.

14. The concrete composition of claim 1, wherein the MgO material is a magnesium oxide/calcium oxide (MgO/CaO) blend.

15. A hardened concrete structure fabricated from a concrete composition, wherein prior to hardening the concrete composition comprises:
a cement, a fine aggregate, a coarse aggregate and water, wherein a weight ratio of water to cement is between 0.33 and 0.36 and is sufficient for hydraulic setting of the cement;
a magnesium oxide material;
a magnesium aluminosilicate material;
a colloidal silica material;
a colloidal graphene oxide material;
a colloidal titanium dioxide material,
wherein a total amount of water is added to the cement, fine aggregate, coarse aggregate and magnesium oxide material, and wherein 20% of the total water is added in the form of slurries, in which a first slurry containing the magnesium aluminosilicate material comprises 10% of the total water, a second slurry containing the colloidal silica material comprises 5% of the total water, a third slurry containing the graphene oxide material comprises 2.5% of the total water and a fourth slurry containing the colloidal titanium dioxide material comprises 2.5% of the total water.

16. The hardened concrete structure of claim 15, wherein the surface of the hardened concrete structure is free from cracks having a width greater than 0.001 mm.

17. The hardened concrete structure of claim 15, wherein the concrete composition further comprises a plasticizer admixture component.

18. The hardened concrete structure of claim 15, further comprising a water reducer admixture component.

19. The hardened concrete structure of claim 15, wherein the concrete composition further comprises natural or synthetic fibers homogeneously distributed throughout the concrete composition, selected from the following: glass fibers, steel fibers, nylon fibers, polyvinyl alcohol fibers and polypropylene fibers.

20. The concrete composition of claim 15, wherein the MgO material is a magnesium oxide/calcium oxide (MgO/CaO) blend.
